(19) United States
(12) Patent Application Publication
(10) Pub. No.: US 2020/0233547 A1
(43) Pub. Date: Jul. 23, 2020

(54) Context Aware Typing System to Direct Input to Appropriate Applications

(71) Applicant: International Business Machines Corporation, Armonk, NY (US)

(72) Inventors: Vijai Kalathur, Wappingers Falls, NY (US); Muneeb Arshad, Poughkeepsie, NY (US); Gregory Ecock, White Plains, NY (US); Megan Capobianco, Highland, NY (US); Christopher Potter, Poughkeepsie, NY (US); Daniela Regier, New Paltz, NY (US)

(21) Appl. No.: 16/250,093

(22) Filed: Jan. 17, 2019

(51) Int. Cl. G06F 3/0484; G06N 20/00; G06F 3/0481

(52) U.S. Cl. CPC G06F 3/0484; G06F 3/0481; G06N 20/00

(57) ABSTRACT

An approach is provided that receives a textual user input at a graphical user interface (GUI) that is displayed on a display screen. The GUI includes a number of windows that each correspond to a different application with one of the windows having the input focus. The approach determines an input context type for the received textual input and compares the input context type to application contexts that correspond to the applications being displayed in the windows. One of the applications is selected based on the comparison and the received textual user input is then directed to the window that corresponds to the selected application.

### BACKGROUND OF THE INVENTION

### Description of Related Art

When entering text on a computer system with a graphical user interface (GUI), the user directs input to one of a multitude of windows that might appear in the GUI. A GUI is a form of user interface that allows users to interact with electronic devices, such as tablet computer systems, desktop computer systems, mobile computer systems, smart phones, and the like through graphical icons and application containers called windows. A GUI is often easier for a newer user that is unfamiliar with a system as it provides visual indicators rather than text-based user interfaces, typed command labels or text navigation.

### SUMMARY

An approach is provided that receives a textual user input at a graphical user interface (GUI) that is displayed on a display screen. The GUI includes a number of windows that each correspond to a different application with one of the windows having the input focus. The approach determines an input context type for the received textual input and compares the input context type to application contexts that correspond to the applications being displayed in the windows. One of the applications is selected based on the comparison and the received textual user input is then directed to the window that corresponds to the selected application.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram that shows a user interacting with a context aware typing system that directs user input to an appropriate application;

FIG. 4 is a depiction of a flowchart showing the logic performed by a context aware input manager;

FIG. 5 is a depiction of a flowchart showing the logic used to direct user input away from an application that currently has focus; and

FIG. 6 is a depiction of a flowchart showing the logic used to handle a change detected to an application.

### DETAILED DESCRIPTION

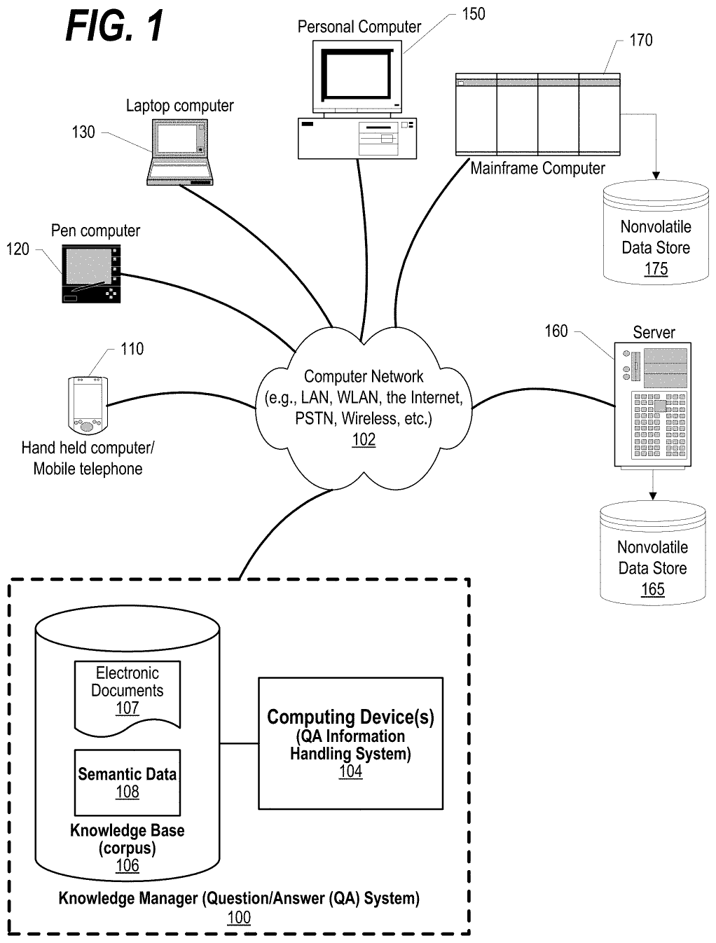

FIGS. 1-6 describe an approach that monitors user input to correctly direct each input to the proper user application window. In traditional systems, if a user is in a hurry or careless, the user can accidentally enter data at one window when intending to enter the information in a different window. This approach includes both an active and a passive component. The passive component of the system monitors user input and records both the input and the application to which it is sent. The passive component is also able to determine patterns in user input and associate applications. For example, the component can match username and password input to specific authentication forms, match code entry to a specific IDE, and match system paths to file browsers

The active component of the system examines user input while the input is being entered by the user. When an application requests a focus switch, the active system examines input surrounding the event, including events both before and after the focus switch. When the system determines that the user has finished inputting data, the active component examines the input and directs it as necessary to either the newly in-focus window or the previously in-focus window.

Attaching context awareness to all input entered by the user differentiates our invention from existing art which focuses on predefined conditions. Traditional systems attempt to determine when to switch focus. The approach described herein improves the accuracy of focus switching and also helps guide input to the correct application after a focus switch has occurred.

This invention works through both an active and a passive component. The passive component is used to generate a backing database of user information. The system monitors user input and attempts to generate both one-to-one relationships between specific strings and applications as well as generalized relationships between types of input and applications.

For specific one-to-one relationships, the system matches specific strings and records the application to which they are being entered. If the user has a specific username and password string that consistently gets entered into an application, the system associates those username/password strings with that application. For more general relationships the system associates types of strings (not specific language) with applications. If the user types file paths (e.g., “/home/user/bin,” etc.) regularly into a file browser the system will associate the file browser with file path strings. Another example would be the system recognizing the user entering code into a specific IDE, and linking text that looks like programming language code to the IDE.

Once these passive systems have a body of relationships established, the active system utilizes the information to solving the problem of application focus change during a user input. As a user is entering input to the computer, the focus may change in the middle of that input. If the system detects this occurring, it examines the input being entered by the user. The system then matches the input to an application and directs the input to the correct application (either the new application that has focus, or the most recent application which lost focus). In this way user input is not entered into the wrong application, potentially causing a breach of sensitive information.

Inventive Advantages

The inventors have discovered a system that provides significant advantages over prior art systems. The inventors' system improves system accuracy when focus switching and also help guide input to the correct application after a focus switch has occurred (improves system accuracy). This invention works through both an active and a passive component. The system also prevents sensitive or confidential information from accidentally being input to the wrong application, potentially causing a breach of such sensitive information (improves computer system security). In addition, preventing erroneous inputs to systems prevents or reduces the amount of time and resources spent removing such erroneous inputs from such systems so that fewer computing resources, including system personnel, are needed to correct from such erroneous inputs (reduces use of computing resources).

Terminology and Scope

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of a question/answer creation (QA) system 100 in a computer network 102. QA system 100 may include a knowledge manager computing device 104 (comprising one or more processors and one or more memories, and potentially any other computing device elements generally known in the art including buses, storage devices, communication interfaces, and the like) that connects QA system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments of QA system 100 may be used with components, systems, sub-systems, and/or devices other than those that are depicted herein.

QA system 100 may be configured to receive inputs from various sources. For example, QA system 100 may receive input from the network 102, a corpus of electronic documents 107 or other data, a content creator, content users, and other possible sources of input. In one embodiment, some or all of the inputs to QA system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with QA system 100. Electronic documents 107 may include any file, text, article, or source of data for use in QA system 100. Content users may access QA system 100 via a network connection or an Internet connection to the network 102, and may input questions to QA system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. QA system 100 may interpret the question and provide a response to the content user containing one or more answers to the question. In some embodiments, QA system 100 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question.

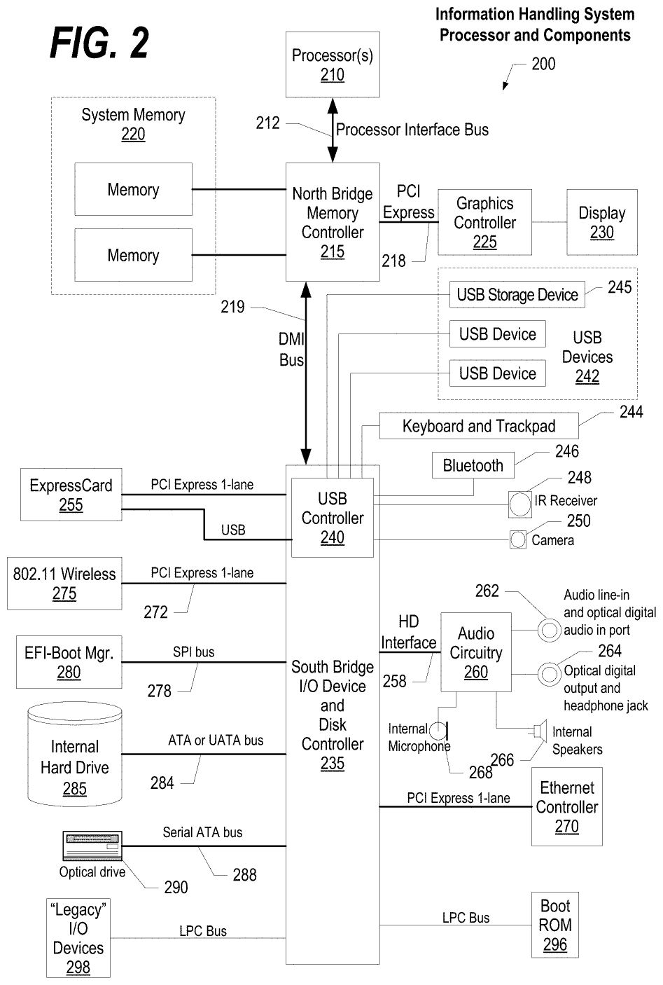

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

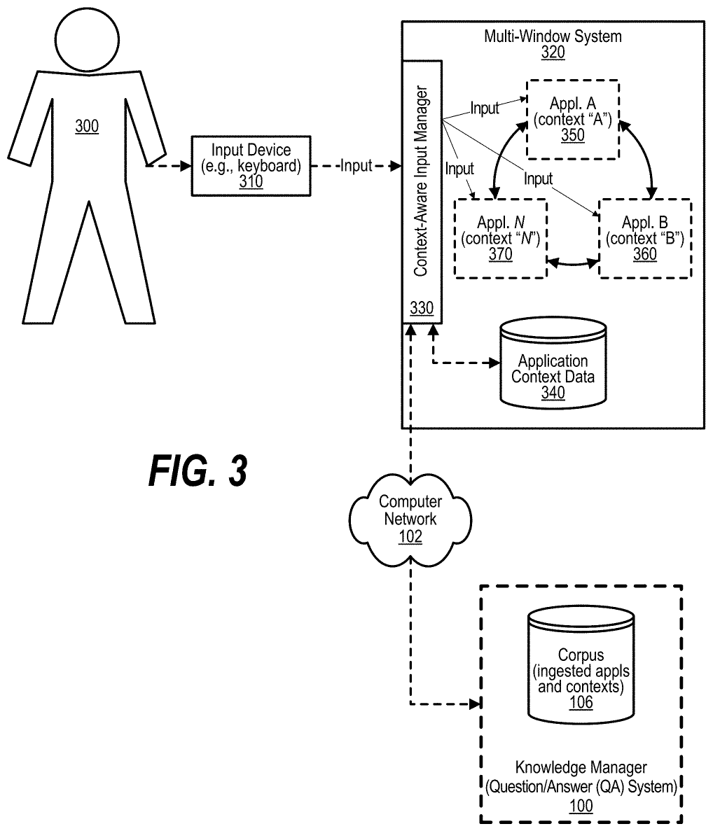

FIG. 3 is a component diagram that shows a user interacting with a context aware typing system that directs user input to an appropriate application. An approach is provided that receives a textual user input at a graphical user interface (GUI) that is displayed on a display screen. The textual user input is received from user 300 that utilizes input device 310, such as a keyboard or keypad, to enter the textual user input. The GUI includes a number of windows that each correspond to a different application with one of the windows having the input focus. Windows used to display different applications are depicted as applications A, B, and N and depicted as being displayed in windows 350, 360, and 370, respectively. Context-aware input manager 330 receives the textual user input and determines an input context type for the received textual input and further compares the input context type to application contexts that correspond to applications A, B, and N being displayed in windows 350, 360, and 370, respectively. Application context data is retrieved from data store 340. One of the applications is selected based on the comparison and the received textual user input is then directed to the window that corresponds to the selected application.

In one embodiment, the context-aware input manager utilizes a machine learning system, such as question-answering (QA) system 100, that is trained using the textual user inputs received at the system along with the corresponding application. Data learned by the machine learning system is stored in corpus 106 with this data including the ingested applications and corresponding application context data. Once trained, the machine learning system can be utilized by context aware input manager 330 to identify and retrieve the application contexts corresponding to the various applications. In a further embodiment, a set of textual context data is retrieved from data displayed on each of the windows corresponding to the various applications and these sets of textual context data are used to further train the machine learning system by inputting the sets of textual context data to the machine learning system.

In a further embodiment, a new application is detected as being opened by the user in a new window of the system. In response to identifying that the machine learning system does not have context data corresponding to the new application, the approach retrieves a new set of textual context data displayed on the new window and then further trains the machine learning system by inputting the new application and the new set of textual context data to the machine learning system.

In one embodiment, each of the comparisons between the input context corresponding to the received textual user input and the application contexts corresponding to each of the applications is scored resulting in a context match score with each of the context match scores corresponding to a different application. In one embodiment, the received textual user input is directed to the window corresponding to the application that has the highest context match score. In an alternative embodiment, the scores are compared to a threshold with the received textual user input being directed to the application with the highest score if the high score reached the threshold, while the input is directed to the window with input focus if the high score does not reach the threshold.

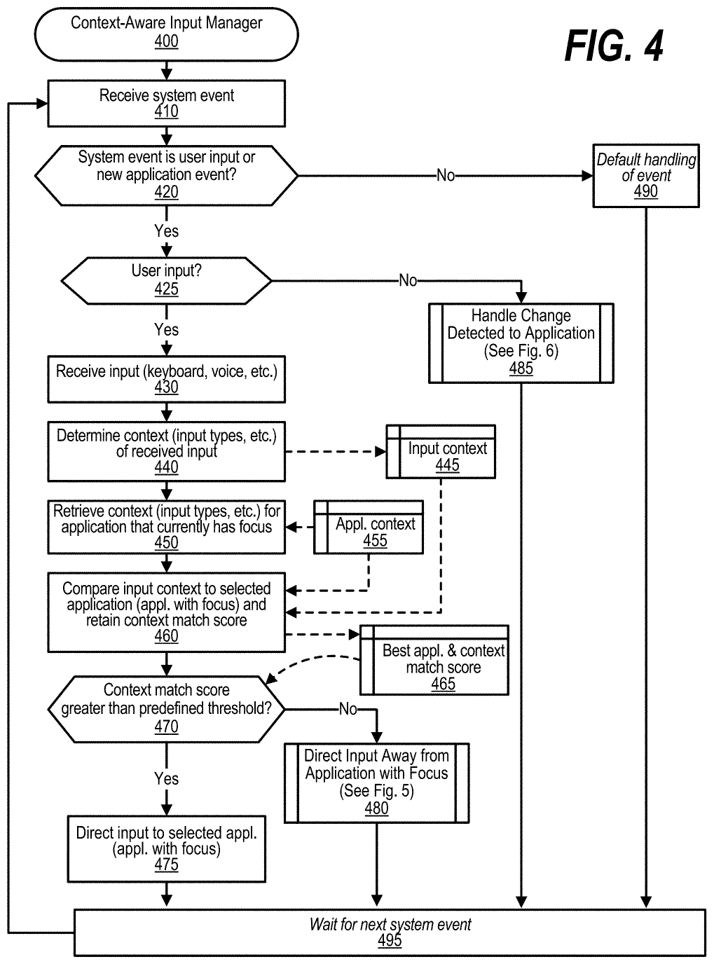

FIG. 4 is a depiction of a flowchart showing the logic performed by a context aware input manager. FIG. 4 processing commences at 400 and shows the steps taken by a process that context-Aware Input Manager. At step 410, the process receives a system event to process. The process determines as to whether the system event is a textual user input or a new application event (decision 420). If the system event is either a textual user input or a new application event, then decision 420 branches to the ‘yes’ branch for further. On the other hand, if the system event is not a textual user input or a new application event, then decision 420 branches to the ‘no’ branch whereupon, at step 490, the system performs default handling of the event.

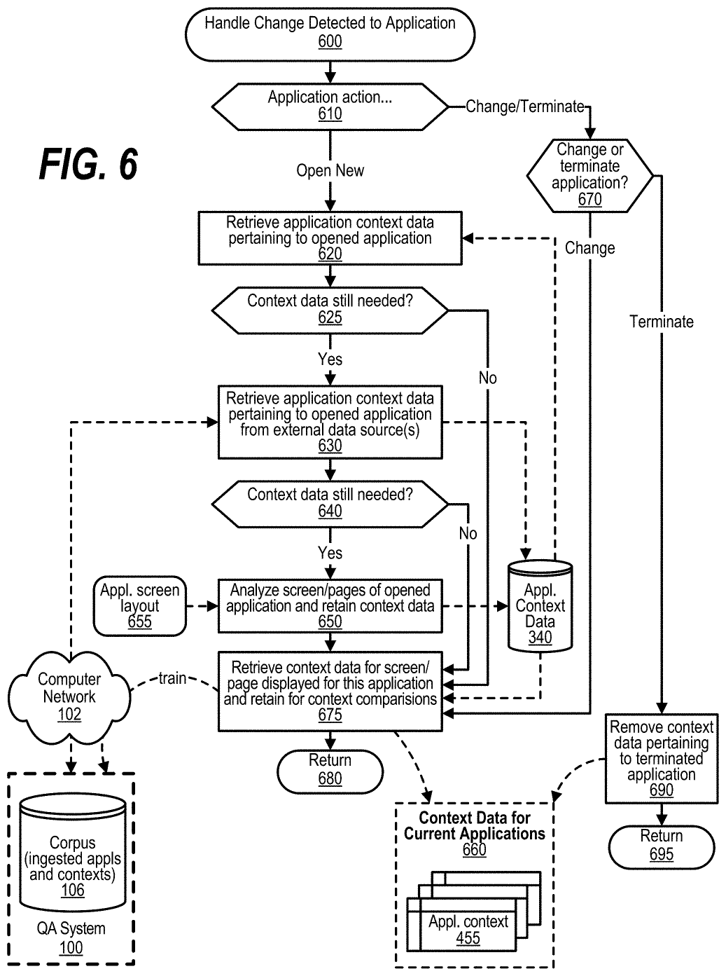

In response to the system event being either a textual user input or a new application event, then at decision 425, the process determines whether the event is the receipt of user textual input. If the event is the receipt of user textual input, then decision 425 branches to the ‘yes’ branch for further processing. On the other hand, if the event is not the receipt of user textual input (a new application event), then decision 425 branches to the ‘no’ branch whereupon, at predefined process 485, the process performs the Handle Change Detected to Application routine (see FIG. 6 and corresponding text for processing details).

Steps 430 through 480 are performed in response to the system event being the reception of textual user input. At step 430, the process receives the textual user input, such as being input at a keyboard or keypad or by being input using voice-to-text with the user speaking into a microphone of the system. At step 440, the process determines the input context type (input types, etc.) for the received textual user input. The determined input context type data is stored in memory area 445. At step 450, the process retrieves the application context (input types, etc.) for the application that currently has input focus from memory area 455. Application context data is loaded into memory area 455 whenever a new application is opened, as discussed with respect to predefined process 485 (see FIG. 6 and corresponding text for further details).

At step 460, the process compares the input context type to the selected application's (the application with input focus) context type and retains a context match score that scores how well the input context type matches the application context type. The context match scores along with the application corresponding to the score are stored in memory area 465. Traditional comparison scoring tools and algorithms can be utilized to generate a context match.

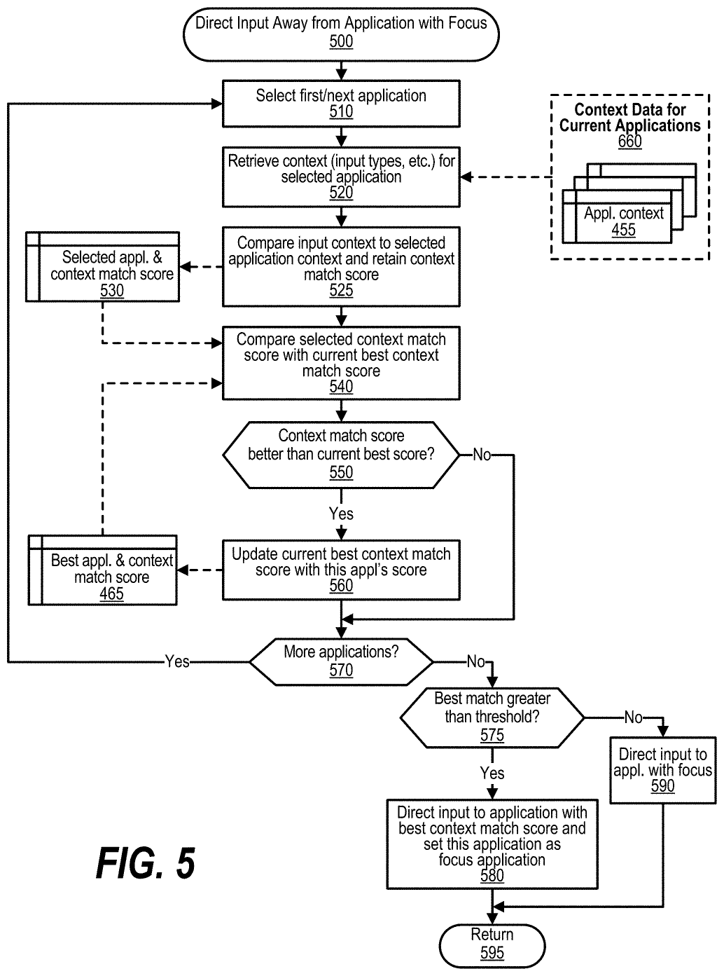

The process determines as to whether the context match score reaches a predefined threshold (decision 470). If the context match score reaches the predefined threshold, then decision 470 branches to the ‘yes’ branch whereupon, at step 475 the process directs the received textual user input to the selected application, in this case the application with focus. On the other hand, if the context match score fails to reach the predefined threshold, then decision 470 branches to the ‘no’ branch whereupon, at predefined process 480, the process performs the Direct Input Away from Application with Focus routine (see FIG. 5 and corresponding text for processing details).

After the received system event has been handled, as described above, then, at step 495, the process waits for next system event. When the next system event is received the process loops back to step 410 to receive and process the newly received system event as discussed above. This looping continues until the system is shutdown.

FIG. 5 is a depiction of a flowchart showing the logic used to direct user input away from an application that currently has focus. FIG. 5 processing commences at 500 and shows the steps taken by a process that directs input away from the application window that currently has input focus. At step 510, the process selects the first application that is currently opened and running in the system.

At step 520, the process retrieves the application context data (input types, etc.) corresponding to the selected application with the application context data being retrieved from contexts memory area 660 that are loaded whenever a new application is opened in the system. At step 525, the process compares the input context data to the selected application context data and retains a context match score based on the comparison. The context match scores and the corresponding applications are stored in memory area 530.

At step 540, the process compares the selected context match score with the current best context match score that is retrieved from memory area 465. The process determines as to whether the selected context match score is better than the current best context match score (decision 550). If the selected context match score is better than the current best context match score, then decision 550 branches to the ‘yes’ branch whereupon, at step 560, the process updates the current best context match score data in memory area 465 with the selected context match score and the corresponding application. On the other hand, if the selected context match score is not better than the current best context match score, then decision 550 branches to the ‘no’ branch bypassing step 560.

The process determines as to whether there are more applications to process and score with comparison to the input context data (decision 570). If there are more applications to process, then decision 570 branches to the ‘yes’ branch which loops back to step 510 to select and process the next application as described above. This looping continues until all of the applications have been processed, at which point decision 570 branches to the ‘no’ branch exiting the loop.

After all of the applications have been processed, the process determines as to whether the best context match score reaches a particular threshold (decision 575). If the best context match score reaches the threshold, then decision 575 branches to the ‘yes’ branch whereupon, at step 580 the process directs the received textual user input to the application with the best context match score and sets the window of this application as the window with input focus. On the other hand, if the best context match score fails to reach the threshold, then decision 575 branches to the ‘no’ branch whereupon, at step 590 the process directs the received textual user input to the application that currently has input focus. FIG. 5 processing thereafter returns to the calling routine (see FIG. 4) at 595.

FIG. 6 is a depiction of a flowchart showing the logic used to handle a change detected to an application. FIG. 6 processing commences at 600 and shows the steps taken by a process that handles a change that is detected to an application, such as a newly opened application, a change to an application, or termination of an application. The process determines the application action (decision 610). If the application action is the opening of a new application, then decision 610 branches to the ‘Open New’ branch to perform steps 620 through 680. On the other hand, if the application action is either a change to an application or termination of an application, then decision 610 branches to the ‘Change/Terminate’ branch to perform steps 670 through 695.

Steps 620 through 680 are performed when a new application is opened. At step 620, the process retrieves the application context data that pertains to the newly opened application. This application context data is retrieved from data store 340. In one embodiment, a machine learning system, such as QA system 100, is used to ingest and store the application context data that is then retrieved when an application is opened. The process determines as to whether context data is still needed for the newly opened application, such as for an application for which context data has not yet been retrieved (decision 625). If context data is still needed for the newly opened application, then decision 625 branches to the ‘yes’ branch to gather the application context data using steps 630 through 650. On the other hand, if the application context data is already available for the newly opened application, then decision 625 branches to the ‘no’ branch bypassing steps 630 through 650.

Steps 630 through 650 are performed to retrieve new application context data for a newly opened application. At step 630, the process retrieves the application context data pertaining to the newly opened application from one or more external data sources. These external data sources might include network accessible sources accessed via computer network 102, such as the Internet, and might further include data stored in one or more machine learning systems, such as QA system 100. The process determines as to whether application context data is still needed for the newly opened application because such context data could not be obtained from external data sources (decision 640).

If application context data is still needed for the newly opened application, then decision 640 branches to the ‘yes’ branch to perform step 650 whereupon the process analyzes the window pertaining to the newly opened application from application screen layout 655 with screen data and other accessible application pages being analyzed. The application context data resulting from the analysis is stored in data store 340 and also ingested, or input, into the machine learning system, such as QA system 100. Returning to decision 640, if application context data has been retrieved for the newly opened application, then decision 640 branches to the ‘no’ branch bypassing step 650.

At step 675, the process retrieves the application context data for screen/page displayed for this application and retain for context comparisons with the data being ingested by the machine learning system. FIG. 6 processing thereafter returns to the calling routine (see FIG. 4) at 680.

Returning to decision 610, if the action is to change or terminate an application then the process determines whether the action is to change or terminate application (decision 670). If the action is to change the application, then decision 670 branches to the ‘Change’ branch which branches down to step 675 to retrieve context data for the screen or page that is displayed in the window containing the application. On the other hand, if the action is to terminate an application, then decision 670 branches to the ‘Terminate’ branch whereupon, at step 690 the process removes context data pertaining to terminated application from memory area 660. FIG. 6 processing thereafter returns to the calling routine (see FIG. 4) at 695.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. (canceled)

2. (canceled)

3. (canceled)

4. (canceled)

5. (canceled)

6. (canceled)

7. (canceled)

8. An information handling system comprising:
one or more processors;
a memory coupled to at least one of the processors;
a display screen accessible by at least one of the processors; and
a set of computer program instructions stored in the memory and executed by at least one of the processors in order to perform actions comprising:
receiving a textual user input at a graphical user interface (GUI) displayed on the display screen, wherein the GUI includes a plurality of windows that correspond to a plurality of applications, and wherein one of the windows has an input focus;
determining an input context type of the received textual input;
comparing the determined input context type to a plurality of application contexts that correspond to the plurality of applications;
selecting one of the plurality of applications based on the comparison; and
directing the received textual user input to the window that corresponds to the selected application.

9. The information handling system of claim 8 wherein the actions further comprise:
training a machine learning system, wherein the training includes the textual user input and the selected application.

10. The information handling system of claim 9 wherein the actions further comprise:
retrieving the plurality of application contexts from the trained machine learning system.

11. The information handling system of claim 10 wherein the actions further comprise:
retrieving a set of textual context data displayed on each of the windows corresponding to the plurality of applications; and
further training the machine learning system by inputting the sets of textual context data to the machine learning system.

12. The information handling system of claim 11 wherein the actions further comprise:
detecting a new application of the plurality of applications being opened in a new window of the plurality of windows;
identifying an absence of context data corresponding to the new application in the machine learning system;
retrieving a new set of textual context data displayed on the new window; and
training the machine learning system by inputting the new application and the new set of textual context data to the machine learning system.

13. The information handling system of claim 9 wherein the actions further comprise:
scoring each of the comparisons resulting in a plurality of context match score wherein each of the context match scores corresponds to a different one of the applications; and
directing the received textual user input to the window corresponding to the application that has the highest context match score.

14. The information handling system of claim 9 wherein the actions further comprise:
scoring each of the comparisons resulting in a plurality of context match score wherein each of the context match scores corresponds to a different one of the applications;
in response to a highest one of the context match scores reaching a threshold, directing the received textual user input to the window corresponding to the application with the highest context match score; and
in response to the highest one of the context match scores failing to reaching the threshold, directing the received textual user input to the window having the input focus.

15. A computer program product stored in a computer readable storage medium, comprising computer program code that, when executed by an information handling system, performs actions comprising:
receiving a textual user input at the information handling system that has a graphical user interface (GUI) displayed on a display screen accessible from the information handling system, wherein the GUI includes a plurality of windows that correspond to a plurality of applications, and wherein one of the windows has an input focus;
determining an input context type of the received textual input;
comparing the determined input context type to a plurality of application contexts that correspond to the plurality of applications;
selecting one of the plurality of applications based on the comparison; and
directing the received textual user input to the window that corresponds to the selected application.

16. The computer program product of claim 15 wherein the actions further comprise:
training a machine learning system, wherein the training includes the textual user input and the selected application.

17. The computer program product of claim 16 wherein the actions further comprise:
retrieving the plurality of application contexts from the trained machine learning system.

18. The computer program product of claim 17 wherein the actions further comprise:
retrieving a set of textual context data displayed on each of the windows corresponding to the plurality of applications; and
further training the machine learning system by inputting the sets of textual context data to the machine learning system.

19. The computer program product of claim 18 wherein the actions further comprise:
detecting a new application of the plurality of applications being opened in a new window of the plurality of windows;
identifying an absence of context data corresponding to the new application in the machine learning system;
retrieving a new set of textual context data displayed on the new window; and
training the machine learning system by inputting the new application and the new set of textual context data to the machine learning system.

20. The computer program product of claim 16 wherein the actions further comprise:
scoring each of the comparisons resulting in a plurality of context match score wherein each of the context match scores corresponds to a different one of the applications;
in response to a highest one of the context match scores reaching a threshold, directing the received textual user input to the window corresponding to the application with the highest context match score; and
in response to the highest one of the context match scores failing to reaching the threshold, directing the received textual user input to the window having the input focus.
